(19) United States
(12) Patent Application Publication
(10) Pub. No.: US 2013/0018817 A1
(43) Pub. Date: Jan. 17, 2013

(54) METHOD AND SYSTEM FOR ONLINE AUTOMATED ASSOCIATION OF INDIVIDUAL RISK TOLERANCE AND RETIREMENT PLAN INVESTMENTS

(71) Applicants: Gregory Newman, Aliso Viejo, CA (US); David Gorsline, Aliso Viejo, CA (US)

(72) Inventors: Gregory Newman, Aliso Viejo, CA (US); David Gorsline, Aliso Viejo, CA (US)

(21) Appl. No.: 13/183,737

(22) Filed: Jul. 15, 2011

(51) Int. Cl. G06Q 40/00

(52) U.S. Cl. 705/36 R

(57) ABSTRACT

An inventive system and method for online automated association of individual risk tolerance and retirement plan investments is presented. The invention comprises a secure online administrative interface that allows a plan administrator to select the available risk profile descriptions from a pre-determined list. The system automatically divides the available scores of any conforming and available risk tolerance questionnaire that includes multiple-choice questions and a scoring algorithm, into equal parts, based on the number of risk profile descriptions selected. A dual-column layout displays selected risk profile descriptions next to a list of plan investments derived from the plan database, and allows a plan administrator to associate each by clicking on investment titles and dragging and dropping them into bordered areas on screen designated for each risk profile description. The system allows multiple investments to be associated with each risk profile description, while restricting the use of each investment to one risk profile, and automatically adjusts the score associated with each investment, based on its placement within a particular risk profile, without increasing or decreasing the overall score range associated with that particular risk profile.

### FIELD OF THE INVENTION

The present invention relates generally to online retirement plan enrollment and management. In particular, the invention relates to a specialized method for associating specific plan investments derived from a database with a specific risk tolerance chosen from a pre-determined list of available risk tolerances.

### BACKGROUND OF THE INVENTION

Currently, online systems for defined-contribution retirement plan management, including 401(k), 403(b), and 457 plans, are limited because they do not provide administrators with sufficient tools to deliver and/or present plan investment choices in a manner that helps plan participants find the investment or investments most closely associated with a participant-selected risk tolerance.

There is a need for a system integrated with the plan database, that allows a retirement plan administrator to associate a particular investment with a risk tolerance.

### SUMMARY OF THE INVENTION

The present invention advantageously provides a system and method for associating specific plan investments derived from a database with a specific risk tolerance chosen from a pre-determined list of available risk tolerances.

The inventive system and method comprises a secure online administrative interface that allows a plan administrator to select the available risk profile descriptions from a pre-determined list. The system automatically divides the available scores of any conforming and available risk tolerance questionnaire that includes multiple-choice questions and a scoring algorithm, into equal parts, based on the number of risk profile descriptions selected. A dual-column layout displays selected risk profile descriptions next to a list of plan investments derived from the plan database, and allows a plan administrator to associate each by clicking on investment titles and dragging and dropping them into bordered areas on screen designated for each risk profile description. The system allows multiple investments to be associated with each risk profile description, while restricting the use of each investment to one risk profile, and automatically adjusts the score associated with each investment, based on its placement within a particular risk profile, without increasing or decreasing the overall score range associated with that particular risk profile.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 shows an exemplary visualization of the present invention initiated by user (admin);

FIG. 2 shows particular risk profiles selected by an administrator user;

FIG. 3 shows an administrator user dragging a particular investment to associate it with a particular risk profile;

FIG. 4 illustrates the display of completed association between investments and risk profiles and the function of saving selections;

FIG. 5 illustrates the display of scoring ranges automatically associated with each risk profile, based on a pre-determined scoring algorithm and the placement of investments within each risk profile;

FIG. 6 is a schematic illustration of an embodiment of the present invention; and

FIG. 7 is a flow diagram of an exemplary embodiment of the present invention.

The foregoing and other objects, aspects, features, advantages of the invention will become more apparent from the following description and from the claims.

### DETAILED DESCRIPTION OF THE INVENTION

A system and method for online automated association of individual risk tolerance and retirement plan investments is presented. One embodiment comprises a network system having a client-server architecture configured for exchanging data over a network. The data exchanges may pertain to various functions, such as plan data, etc., associated with the network system. The network system may include a network-based plan website where plan participants may manage and configure their plans.

The network system also includes a network-based provider having a data exchange platform, to provide server-side functionality via a network, e.g., the Internet, to one or more clients, including users that may utilize the network system through the network-based provider to exchange data over the network. The data exchange may include transactions such as receiving and processing data from a multitude of users. The data may include, but is not limited to, participant personal data, plan investments, plan performance statistics and records, etc.

In an exemplary embodiment, the network-based system, the network-based provider including the data exchange platform, an application program interface (API) server, and a web server are coupled to, and provide programmatic and web interfaces respectively to, one or more application servers. The application servers host one or more networking applications and plan participant applications. The applications servers, in turn, are coupled to one or more database servers that facilitate access to one or more databases. The plan participant application may provide a number of functions and services, e.g., trading, etc., to users that access the network-based system.

This inventive system also embodies the notion of a third-party application, executing on a third-party server machine, as having programmatic access to the network-based system via the programmatic interface provided by the API server. For example, the third-party application may, utilizing information retrieved from the network-based system, support one or more features or functions, such as personalized advice, on a website hosted by the third party. The third-party website may thus provide one or more functions that are supported by the relevant applications of the network-based system. Under such embodiments, multiple applications could be part of the network-based system.

Navigation of the network-based system may be facilitated by one or more navigation applications. For example, a search application may, inter alia, enable key word searches of investments and plans published via the system. A browser application may allow users via an associated user interface to browse various data structures within the system. Various other navigation applications (e.g., an external search engine) may be provided to supplement the search and browsing applications.

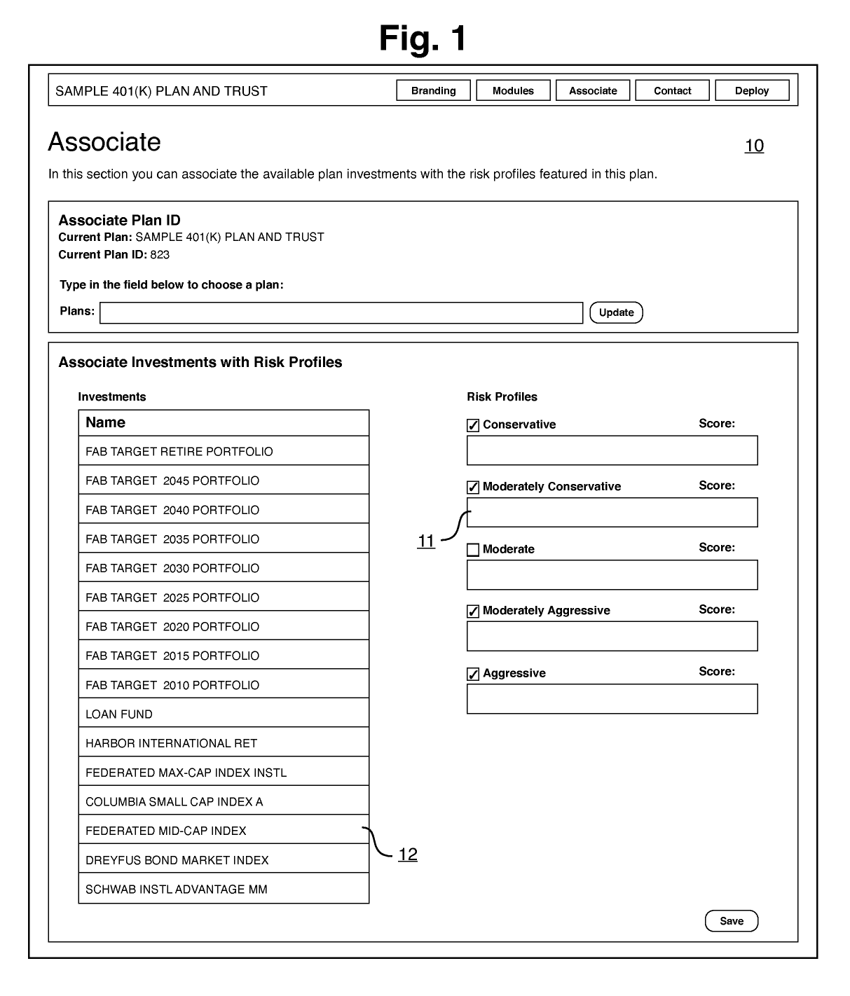

In order to facilitate the association functionality within the system, the inventive system and method includes a specialized “visualization board” functionality. FIG. 1 shows this visualization board 10. Once activated, the visualization board 10 produces a listing of available plan investments in a column 12 next to or nearby the listing of available risk profiles 11, over-layered to the network-based system interface. The visualization board 10 allows users to associate plan investments with particular risk profiles, by manually dragging and dropping an investment within the bounding box associated with a particular risk profile 11.

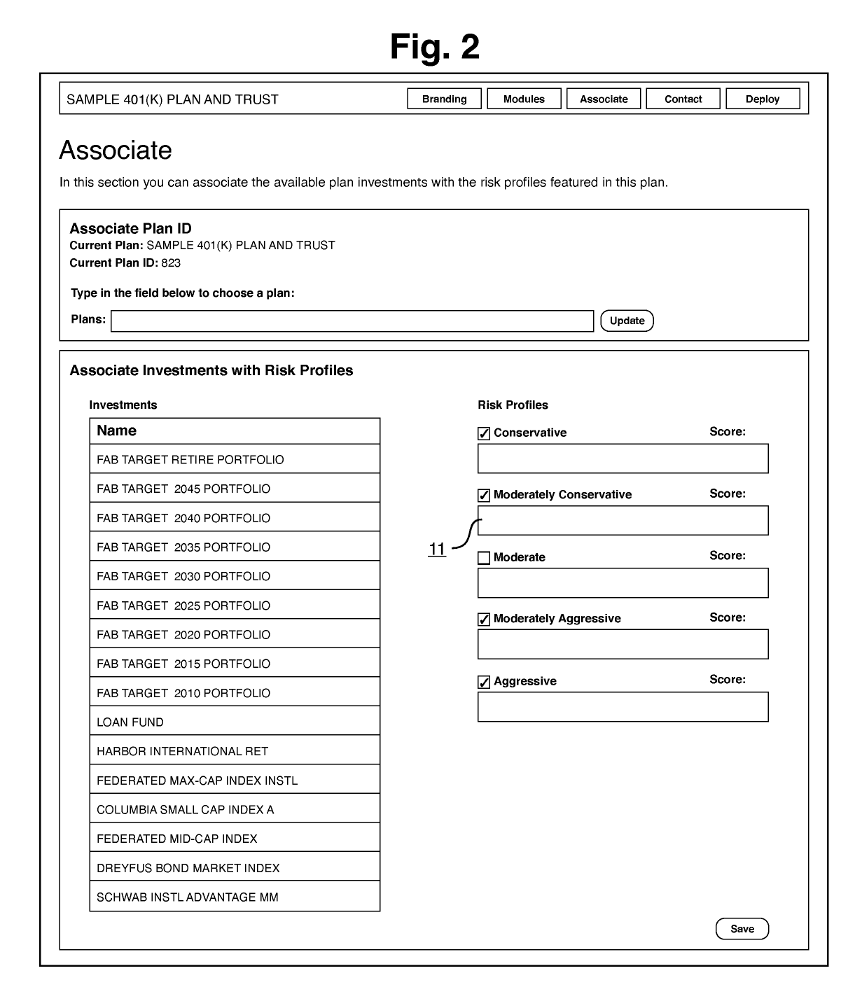

FIG. 2 shows particular risk profiles selected as “active” by admin 11. A particular risk profile is selected by clicking the check box next to its name.

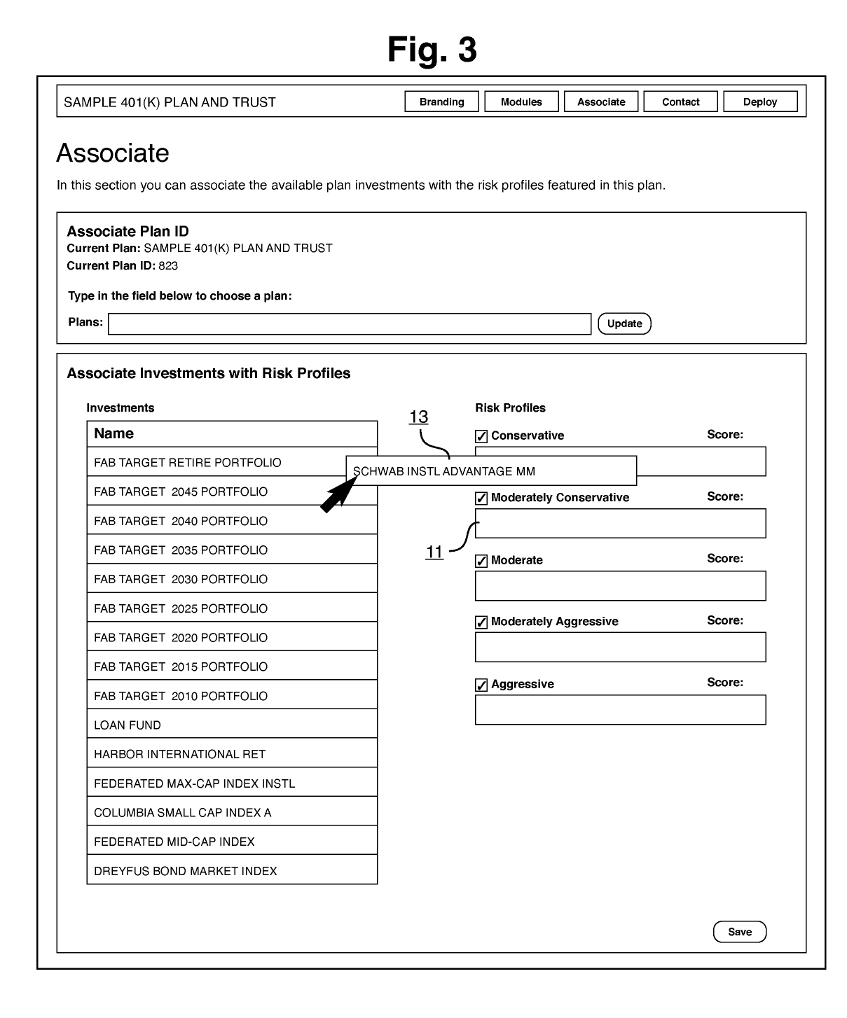

FIG. 3 shows admin dragging a particular plan investment 13 over the bounding box for an active risk profile 11, to associate the investment with that risk profile. Once an investment is dropped into the bounding box for a risk profile 11, it is removed from the list of available plan investments 12.

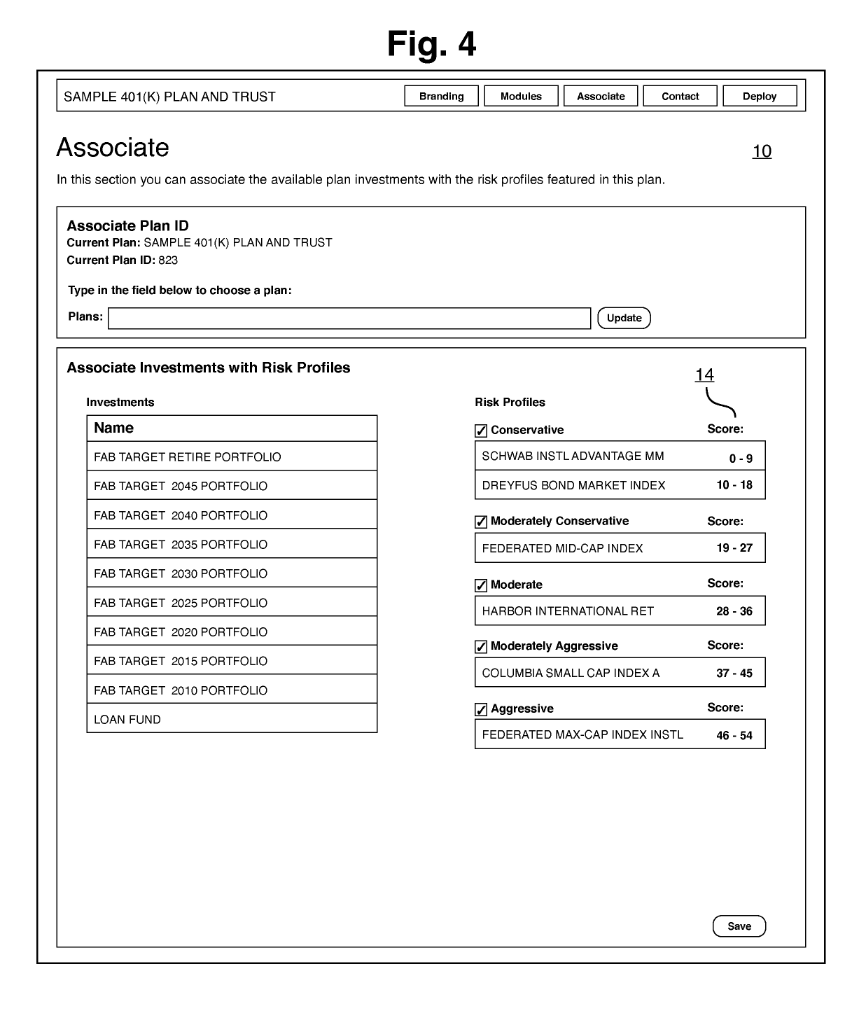

FIG. 4 illustrates the placement of multiple investments within each risk profile, and the score associated with each investment 14; the bounding box for a risk profile 11 expands automatically to accommodate additional investments.

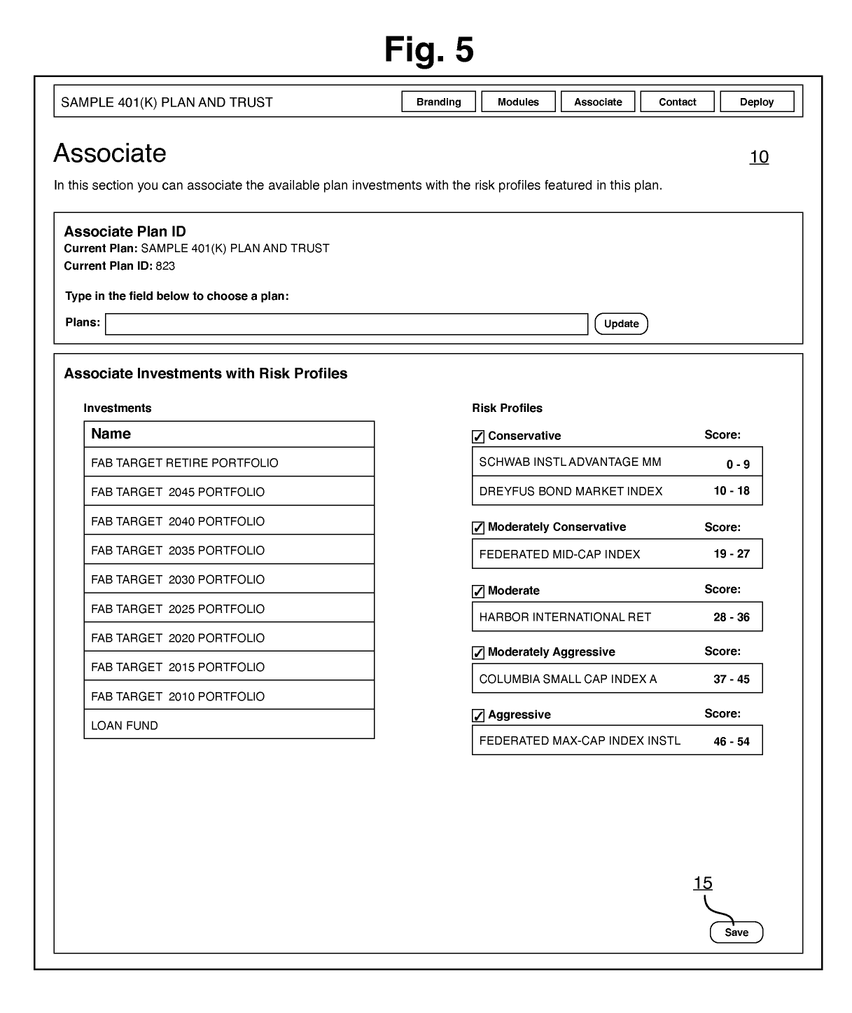

FIG. 5 illustrates the display of completed association between investments and risk profiles on the visualization board 10 and the function of saving selections, via a Save button 15.

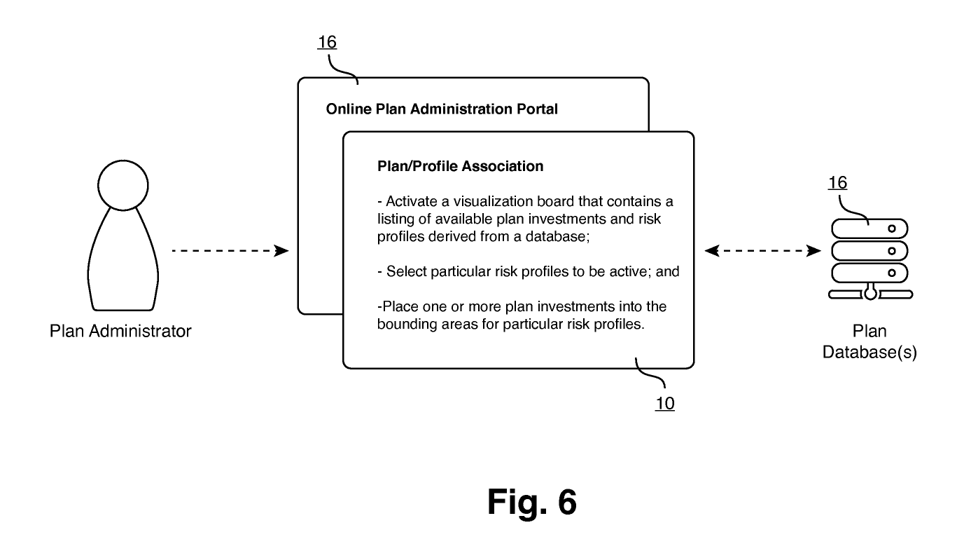

FIG. 6 is a schematic illustration of an embodiment of the present invention in an administration portal 16 and integrated with a retirement plan database 17. As shown in FIG. 5, when the visualization board 10 is activated, the system generates a list of available plan investments and available risk profiles. This information is presented to the user in a layout that allows the user to drag and drop specific investments to specific risk profiles.

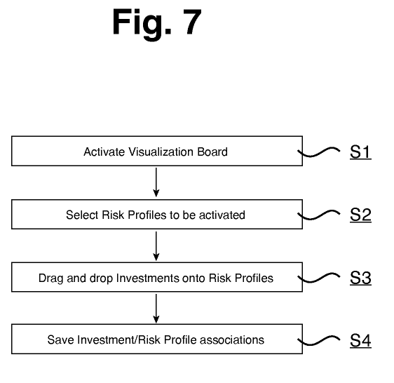

FIG. 7 is a flow diagram of an exemplary embodiment of the present invention. In step S1, a admin activates the visualization board 10 from within an online administration portal 16. In step S2, one or more risk profiles are selected 11. In step S3, the admin drags individual investments 12 onto the bounding box for particular risk profiles 11. In step S4, the user saves the selections, using the Save button 15.

The invention can be implemented as computer software or a computer readable program for operating on a computer. The computer program can be stored on computer readable medium. Various aspects of the present disclosure may be embodied as a program, software, or computer instructions embodied in a computer or machine usable or readable medium, which causes the computer or machine to perform the steps of the method when executed on the computer, processor, and/or machine.

System and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention.

What is claimed is:

1. A method for online automated association of individual risk tolerance and retirement plan investments comprising:
activating a visualization board that contains a listing of available plan investments and risk profiles derived from a database;
selecting particular risk profiles to be active; and
placing one or more plan investments into a bounding area for particular risk profile created using keylines within the visualization board.

2. The method according to claim 1, wherein said step of activated a visualization board is performed by navigating through an online administration interface.

3. The method according to claim 1, wherein said step of available plan investments comprises displaying plan investment names as derived from a database.

4. The method according to claim 1, wherein said step of available risk profiles comprises displaying risk profile names as derived from a database.

5. The method according to claim 1, wherein said step of selecting a particular risk profile to be active comprises clicking on a check box associated with that risk profile.

6. The method according to claim 1, wherein said step of placing a plan investment into the bounding area for particular risk profile comprises dragging the plan investment name on top of the selected bounding area and dropping it to make the selection.

7. The method according to claim 1, wherein said step of placing a plan investment into the bounding area for particular risk profile automatically removes said investment from the list of investments available to be associated with a risk profile.

8. The method according to claim 1, wherein said step of placing a plan investment into the bounding area for particular risk profile automatically adjusts the score assigned from a pre-existing risk tolerance questionnaire scoring algorithm, to associate said investment with the chosen risk profile description.

9. The method according to claim 1, wherein said step of moving a plan investment within the bounding area for particular risk profile, relative to other investments situated within the same bounding area, automatically adjusts the score assigned from a pre-existing risk tolerance questionnaire scoring algorithm.

10. (canceled)

11. A computer readable medium having computer readable program for operating on a computer for executing the network-based system, said program comprising instructions that cause the computer to perform the steps of:
activating a visualization board;
displaying a listing of available plan investments and risk profiles, as derived from a database;
placing one or more investments within a particular risk profile; and
saving the choices to a database.
